(19) United States
(12) Patent Application Publication
(10) Pub. No.: US 2007/0059493 A1
(43) Pub. Date: Mar. 15, 2007

(54) Wet-slip resistant sheet and wet-slip resistant structure

(75) Inventor: Takahide Okuyama, Yamagata-pref. (JP)

Correspondence Address: 3M INNOVATIVE PROPERTIES COMPANY, PO BOX 33427, ST. PAUL, MN, 55133-3427, US

(73) Assignee: 3M INNOVATIVE PROPERTIES COMPANY, Saint Paul,, MN (US)

(21) Appl. No.: 10/558,918

(22) PCT Filed: Jun. 1, 2004
(86) PCT No.: PCT/US04/17374

§ 371 Date: Dec. 1, 2005

(30) Foreign Application Priority Data
Jun. 2, 2003 (JP) 2003-156216

(51) Int. Cl. B32B 3/00

(52) U.S. Cl. 428/156; 428/141

(57) ABSTRACT

To provide a wet-slip resistant sheet which can be suitably connected with other wet-slip resistant sheet while satisfying the wet-slip resistance property. A wet-slip resistant sheet comprising: a substrate having a surface and a back face opposing to said surface, and anti-skid parts and flat parts, which are preferably in the lattice or stripe form, provided on said surface of the substrate, wherein each of said anti-skid parts is separated by said flat parts.

### BACKGROUND

The present invention relates to a wet-slip resistant sheet and a wet-slip resistant structure. In particular, the present invention relates to a wet-slip resistant sheet comprising anti-skid parts and flat parts which are preferably in the form of lattices or stripes, wherein each of the anti-skid parts is separated by the flat parts, and a wet-slip resistant structure comprising such a wet-slip resistant sheet and a floor. The wet-slip resistant sheets of the present invention have wet-slip resistance suitable for use as a floor surface and effectively prevent lifting or peeling of the sheets in a laminated region when a plurality of the sheets are set in place by laminating the edges of the sheets.

The wet-slip resistant sheet of the present invention is useful as a slip-resistant sheet for a floor surface, which has an adhesive layer fixed to the back face of the substrate and is fixed to a floor surface through the adhesive layer. In addition, the substrate is light-transmission, and thus the wet-slip resistant sheet of the present invention is useful as a graphics-protective sheet which protects the graphics formed between the substrate and the floor surface. The graphics-protective sheet is particularly useful as a protective layer of a decorative sheet which has graphics fixed to the back face of the substrate and decorate the floor surface.

### SUMMARY

Hitherto, graphics are drawn on a base film or a recording medium with a printing means such as an electrostatic printing method or an ink jet printing method, and the film or the medium having the graphics drawn is used as a sign for advertising or guiding. The film or the medium having the graphics drawn is fixed to the surface of a material such as a floor surface of a construct through an adhesive layer which is provided on the back face of the base film or the medium. To protect the graphics from damage, stain, etc., a graphics-protective sheet comprising a film or a sheet with a high light transmittance is laminated on the surface of the film or the substrate having the graphics drawn. The graphics-protective sheet is adhered to the film or the substrate having the graphics drawn through an adhesive layer, so that the graphics can be seen through the graphics-protective sheet.

A product such as the decorative sheet having the graphics protected with the protective sheet is recently used as a decorative sheet for a floor surface. The decorative sheet for the floor surface is used by adhering it to a floor (or a material constructing a floor) for simple repairing or as an advertising or guiding sign at a place having a relatively large number of passersby in a hotel, a shop, etc. Since the decorative sheet for the floor surface is used in such a way, it is required to have different properties from a decorative sheet for a signboard or a wall. One of such properties is wet-slip resistance on the surface of the sheet, since the decorative sheet for the floor surface should effectively prevent the slippage of the sole of a foot of the passerby (including a shoe's sole) so that the passerby can walk on the sheet with no unusual feeling such as if the sheet was not present.

A nonslip sheet or a slip-resistant sheet which is fixed to the floor surface has a roughened surface and makes use of a gripping effect of protrusions formed by roughening. Many slip-resistant sheets are found here and there, and are generally of two types. In one type, inorganic particles which form protrusions on the surface are dispersed and fixed, and in the other type, the sheet surface is roughened to form protrusions.

One example of the former type is a nonslip protective film comprising a soft synthetic resin containing fine particles added thereto as described in JP-A-2-144461 (Patent Literature 1), that is, a method for imparting the abrasion resistance and nonslip function to the film by adding hard particles such as alumina particles to the soft synthetic resin.

One example of the latter type is an article disclosed in U.S. Pat. No. 6,180,228 (Patent Literature 2) (corresponding to WO99/44840 (Patent Literature 3)). This patent specification discloses a graphics article useful as a decorative sheet for a floor surface, that is, a graphics article comprising:

(a) a base film with a first major surface and a second major surface, a base film adhesive layer applied on the first major surface, wherein the base film adhesive layer comprises an adhesive composition selected such that the article will be removable from an outdoor surface, and

an image layer applied to the second major surface of the base film; and

(b) a substantially clear graphics-protective sheet (which is named an image-protective top film in the US patent) with a first major surface and a second major surface, a layer of a substantially clear adhesive on the first major surface, and wherein the second major surface of the image-protective layer is surface-roughened (embossed) to provide a BPN of at least 35 as measured by the procedures specified in ASTM E-303-93;

wherein the graphics-protective sheet is attached to and overlies the base film and the image layer, and the image layer is visible through the graphics-protective sheet.

The image layer affords image information (visually displayed information such as an advertisement, a destination guides, etc.) to observers who see the graphics. The base film may be a vinyl resin film, a polyurethane film, etc., and the adhesive for the base film may be an acrylic adhesive. The clear adhesive for the graphics-protective sheet may be an acrylic pressure-sensitive adhesive.

Such a graphics article creates an outdoor-advertising system when it is fixed to the floor surface. That is, passersby who walk on the graphics article fixed to the floor surface can see the image layer in good conditions, and can walk on the graphics article with no unusual feeling such as if the article was not present.

When the slip resistant sheet is fixed to a floor surface of a building which directly or indirectly communicates with outdoors, passersby walk on the sheet in the undried state. Water from outdoors is generated from, for example, rain or snow and is conveyed onto the sheet spontaneously, or with moving bodies such as passersby, animals, goods, etc. The slip resistant sheet used on the floor surface should have an improved function to prevent the slippage of the sole of a foot of the passerby (including a shoe's sole) on the sheet surface, that is, the improved wet-slip resistance. From such a viewpoint, the BPN value, which is measured according to ASTM E-303-93, should be at least 35 as disclosed in Patent Literature 2.

It is necessary to control the shape of the sheet surface to adjust the measured BPN value in the specific range. To achieve this, JP-A 2003-39582 (Patent Literature 4) discloses a wet-slip resistant sheet which adjusts an arrangement density (D) of protrusions on the sheet surface and a profile index (PI) of the whole protrusions.

### BRIEF DESCRIPTION OF THE DRAWINGS

FIG. 1 is a plan view of one example of the wet-slip resistant sheet of the present invention.

FIG. 2 is a vertical cross sectional view of along the line X₁-X₂ in FIG. 1.

FIG. 3 is a cross sectional view of the wet-slip resistant sheets of the present invention, which are used as graphics-protective sheets.

FIG. 4 is a cross sectional view of the wet-slip resistant sheets of the present invention, each of which has a decorative layer.

### DETAILED DESCRIPTION

However, when a floor having a large area is covered, one wet-slip resistant sheet cannot cover all the desired area of the floor, and thus two or more wet-slip resistant sheets are used with joining them. In such a case, the edges of the adjacent wet-slip resistant sheets are laminated. However, when the back face of one sheet is laminated on the surface of another sheet with an adhesive layer, the adhesive layer does not adhere to the roughened surface of the sheet, since the surface of the wet-slip resistant sheets is roughened to attain the grip effect. Therefore, the sheet is easily peeled from the laminated part.

Then, flat parts were partly formed on the surfaces of wet-slip resistant sheets and the sheets were laminated at the flat parts. When the back face of one sheet was laminated on the flat part of another sheet with an adhesive layer provided on one sheet, the peeling from the laminated part could be effectively prevented.

However, if the width of the flat part is too large, the wet-slip resistance property greatly varies from part to part where the property is measured, and thus the slipping occurs partly between the sole of a foot of a passersby (including a shoe's sole) and the surface of the wet-slip resistant sheet.

If the width of the flat part is too small, the adhered area becomes small so that the adhesion property decreases, so that the laminated part of the sheet is lifted, and it may be difficult to correctly position the sheets when they are laminated.

Thus, an object of the present invention is to provide a wet-slip resistant sheet which can be suitably connected with another wet-slip resistant sheet while satisfying the wet-slip resistance property.

As a result of researches and experiments, the inventors have found that a wet-slip resistant sheet satisfying the wet-slip resistance property is obtained, when anti-skid parts and flat parts, which are preferably in the form of lattices or stripes, are formed on the surface of a substrate of the slip resistant sheet and the anti-skid parts are separated by the flat parts. Furthermore, the inventors have found that a wet-slip resistant sheet which can be suitably connected with another wet-slip resistant sheet while satisfying the wet-slip resistance property is obtained, when the width of flat parts is from 7 mm to 25 mm in the case of lattice-form flat parts, while the width of flat parts is from 7 mm to 40 mm in the case of stripe-form flat parts, and the areas of the anti-skid parts and the flat parts and the measured BNP values of the anti-skid parts and the calculated BPN value of the flat parts calculated based on the measured BPN are in the specific ranges.

To produce the wet-slip resistant sheet described above, it is important to control the measured BPN value of the anti-skid parts in a specific range. Thus, the present invention utilizes the fact that the measured BPN value of the anti-skid parts can be easily controlled in the specific range when the arrangement density (D) of a plurality of protrusions and the profile index (PI) of the protrusions are adjusted in the specific ranges.

According to one aspect, the present invention achieves the above object by providing a wet-slip resistant sheet comprising a substrate having a surface and a back face opposing to the surface, and anti-skid parts and flat parts provided on the surface of the substrate, wherein each of the anti-skid parts is separated by the flat parts. According to another aspect, the present invention provides a wet-slip resistant structure comprising a floor of a construct and a wet-slip resistant sheet according to the present invention which is fixed to the surface of the floor, wherein the surface is a floor surface facing outdoors, or an indoor floor surface which is present near an entrance which faces outdoors.

The wet-slip resistant sheet of the present invention is characterized in that it has anti-skid parts and flat parts which are preferably in the form of lattices or stripes on its surface. Since the flat parts are present along the periphery of the sheet, an adhesive layer of one sheet can be bonded to the flat part of other sheet, when the sheets are connected at their respective edges. Thereby, the lifting or peeling of the sheet can be effectively prevented.

In one preferred embodiment of the present invention, the width of the flat part is at least 7 mm in case of the lattice and stripe form, while it does not exceed 25 mm in the case of the lattice form or 40 mm in the case of the stripe form.

When the width of the flat part is at least 7 mm, the lifting or peeling of the sheet is further prevented and the positioning of the sheets is facilitated.

When the upper limit of the width of the flat part is 25 mm in the case of the lattice form or 40 mm in the case of the stripe form, the variation of the wet-slip resistance property from part to part where the property is measured can be suppressed, and thus the slipping, which occurs partially between the sole of a foot of a passersby (including a shoe's sole) and the surface of the wet-slip resistant sheet, can be effectively prevented.

The upper limit of the width of the stripe-form flat part is larger than that of the lattice-form flat part. The reason for this is that since the stripe-form flat parts are arranged in one direction of the sheet, that is, in the length direction or the width direction, the partial slipping can be prevented even when the width of the flat part is large.

In one preferred embodiment, the flat parts are in the lattice form and have a width of 7 mm to 25 mm, and a calculated wet-slip resistance value (calculated BPN value) of at least 35. The calculated wet-slip resistance value is defined by the formula (1):
X=Xf+(Xr−Xf)bd/(a+b)(c+d) (1)
in which
Xr is a measured wet-slip resistance value (a measured BPN value) of anti-skid parts according to ASTM E-303-93,
Xf is a measured wet-slip resistance value (a measured BPN value) of flat parts according to ASTM E-303-93,
a is an average width of flat parts in one direction (unit: mm),
b is an average width of anti-skid parts in one direction (unit: mm),
c is an average width of flat parts in the other direction (unit: mm), and
d is an average width of anti-skid parts in the other direction (unit: mm).

In another preferred embodiment, the flat parts are in the stripe form and have a width of 7 mm to 40 mm and a calculated wet-slip resistance value (calculated BPN value) of at least 35, said calculated wet-slip resistance value being defined by the formula (1′):
X=Xf+(Xr−Xf)b/(a+b) (1′)
in which
Xr is a measured wet-slip resistance value (a measured BPN value) of anti-skid parts according to ASTM E-303-93,
Xf is a measured wet-slip resistance value (a measured BPN value) of flat parts according to ASTM E-303-93,
a is an average width of flat parts (unit: mm), and
b is an average width of anti-skid parts (unit: mm).

When the calculated BPN value defined by the formula (1) is controlled in the specified range, the sheet of the present invention has the sufficient wet-slip resistance property as a slip-resistant floor sheet although it has the lattice-formed flat parts.

To control the calculated BPN value in the specified range, it is important to control the areas of the flat parts and the anti-skid parts and also the measured BPN value of the anti-skid parts. The measured BPN value of the anti-skid parts can be easily controlled by designing the shape and arrangement of the protrusions with using the arrangement density (D) and the profile index (PI) of the protrusions as the guidelines.

To improve the wet-slip resistance property, preferably the measured BPN value of the anti-skid parts is high. However, when the measured BPN value is too high, the clean recovery (i.e. ability to be cleaned) tends to deteriorate. In the case of the slip resistant sheet having a plurality of protrusions on its surface, the protrusions abrade the shoes soles so that abrasion marks (or heel marks) may be formed from the sole materials remaining on the sheet surface or debris generated by the removal of dirt from the soles. When the measured BPN value is too high, the abrasion property of the protrusions on the surface is relatively high, and the abrasion debris tends to be trapped in the grooves between the protrusions. Therefore, when the measured BPN value is too high, the sheet almost loses the clean recovery and thus the abrasion marks may not be removed by relatively simple cleaning methods (e.g. cleaning with water using a brush). Such surface stains caused by the heel marks (Rub-Off Stain), which are hardly removed, tends to be worsened when the protrusions have sharp apexes like pyramids, cones, etc.

To achieve the wet-slip resistance property of the anti-skid parts and the clean recovery at the same time, it is effective to control the arrangement density (D) and the profile index (PI) of the protrusions in the specified ranges, as described in Patent Literature 4, and such technology can be applied to the present invention.

Preferably, the arrangement density (D) of the protrusions is in the range between 50 protrusions/cm² to 3,000 protrusions/cm², and the profile index (PI) of the protrusions is in the range of between 5 and 100, when the profile index (PI) is defined by the formula (2):
PI=D×H² (2)
in which D is an arrangement density of the protrusions (unit: protrusions/cm²), and H is a height of the protrusion (unit: mm).

When the arrangement density (D) of the protrusions is less than 50 protrusions/cm², it is difficult to control the BPN value in the range of at least 35, and increase the wet-slip resistance. It is difficult to form the projections with accurate shapes and sizes at an arrangement density exceeding 3,000 protrusions/cm². As a result, the control of the BPN value becomes difficult.

When PI is less than 5, it is difficult to control the BPN value in the range of at least 35, and increase the wet-slip resistance. When PI exceeds 100, the clean recovery properties deteriorate and the rub-off stain due to the abrasion marks which are hardly removed cannot be effectively prevented.

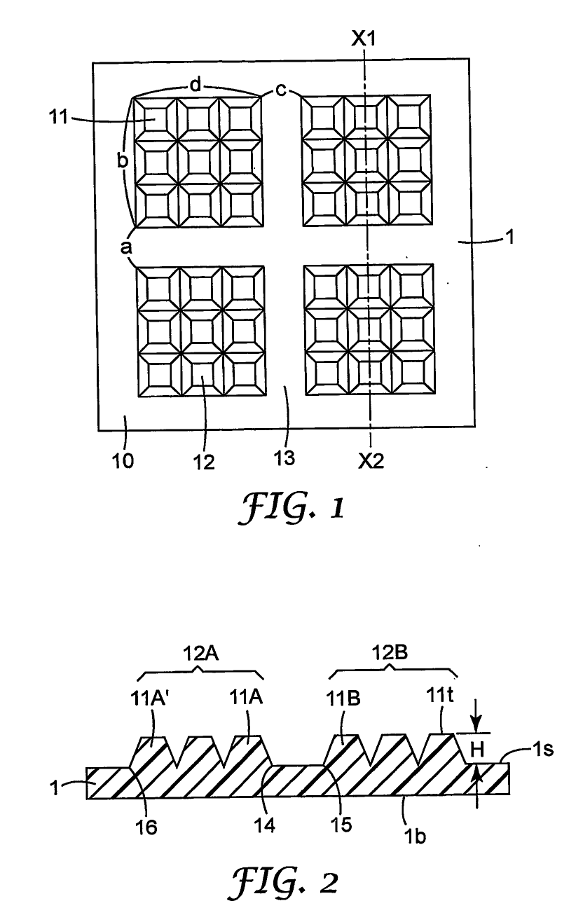

One preferred embodiment of the wet-slip resistant sheet (10) according to the present invention is explained by making reference to FIGS. 1 and 2. FIG. 1 is a schematic plan view of the surface of the wet-slip resistant sheet having the lattice-form flat parts, and FIG. 2 is a schematic vertical cross sectional view of the sheet along the line X₁-X₂ in FIG. 1.

The wet-slip resistant sheet (10) shown in the Figures comprises the support (1) having the surface (1s) and the back face (1b) opposing to the surface (is), and has the anti-skid parts (12) and the lattice-form flat parts (13) on the surface. The protrusions (11) in the anti-skid parts (12) are provided on the surface of the substrate.

In FIG. 1, “a” is a width (mm) of the flat parts (13) in one direction, “b” is a width (mm) of the anti-skid parts in one direction, “c” is a width (mm) of the flat parts in the other direction, and “d” is a width (mm) of the anti-skid parts in the other direction.

When the flat parts are in the form of stripes, the width (mm) of the flat parts is expressed by “a”, and the width (mm) of the anti-skid parts is expressed by “b”.

The above “width” is an average value when the flat parts having different sizes and/or the anti-skid parts having different sizes are present.

The width of the flat part is the shortest distance from the intersection (14) between the side face of the protrusion (11A) provided at one edge in the anti-skid part (12A) and the surface of the flat part to the intersection (15) between the side face of the protrusion (11B) provided at one edge in the adjacent anti-skid part (12B) and the surface of the flat part.

The width of the anti-skid part is the longest distance from the above intersection (14) to the intersection (16) between the side face of the protrusion (11A′) provided at the other edge in the same anti-skid part (12A) and the surface of the flat part.

When the width a and c of the flat part is at least 7 mm, the lifting or peeling of the sheet is further prevented and the positioning of the sheets is facilitated.

When the edges of the sheets are laminated, the lifting of the sheet is evaluated as follows:

One wet-slip resistant sheet having the flat part at the edge of the sheet is set in place on a floor surface. That is, the sheet is fixed to the floor with the back face of the substrate facing the floor. Then, on the surface of the flat part at the edge of the wet-slip resistant sheet, another wet-slip resistant sheet is laminated using the adhesive layer provided on the back face of another sheet. When wet-slip resistant sheets have no flat part at the peripheries of the sheets, a width of 40 mm from the edge of one sheet is laminated on another sheet. After one week from the lamination, the laminated part of the two sheets is evaluated by comparing it with the laminated part just after lamination. That is, the state of lifting or peeling is observed with an eye.

The positioning property of the sheets can be evaluated as follows:

A wet-slip resistant sheet having a length of 1200 mm and a width of 1200 mm and a flat part at its edge is set in place on a floor surface. That is, the sheet is fixed to the floor with the back face of the substrate facing the floor. Then, on the surface of the flat part at the edge of the wet-slip resistant sheet, another wet-slip resistant sheet having the same sizes is set in place so that the edges of the sheets in the width direction are laminated. In this step, it is observed with an eye whether one sheet is laminated only on the surface of the flat part at the edge of the other sheet along the entire width of the sheet (1200 mm). When one sheet is laminated on the surface of the anti-skid part of the other sheet, the positioning property of the sheets is ranked “no good”.

When the width of the flat part is not more than 25 mm in the case of the lattice form or not more than 40 mm in the case of the stripe form, the variation of the wet-slip resistance property from part to part where the property is measure can be suppressed, and thus the slipping, which occurs partially between the sole of a foot of a passersby (including a shoe's sole) and the surface of the wet-slip resistant sheet, can be effectively prevented.

The wet-slip resistance property can be evaluated as follows:

A wet-slip resistant sheet having a length of 1200 mm and a width of 1200 mm and a flat part at its edge is adhered to a floor surface, and the surface of the sheet is fully wet with water. Then, an adult wearing safety shoes (with black rubber soles) walks on the wet sheet and organoleptically evaluates the wet-slip resistance.

When the calculated BPN value defined by the formula (1) is at least 35, the sheet has the sufficient wet-slip resistance property although the lattice-form flat parts are formed.

To achieve the calculated BPN value of at least 35, not only the areas of the flat parts and the anti-skid parts are controlled but also the measured BPN value of the anti-skid parts should be in the specific range. To this end, it is effective to design the arrangement density (D) and the profile index (PI) of the protrusions (11) of the anti-skid parts in the specific ranges.

The measured BPN value of the anti-skid parts is obtained according to ASTM E-303-93. The measured BPN value of the anti-skid parts does not usually exceed 100. When the measured BPN value is too large, it may be difficult to increase the clean recovery.

Preferably, the flat parts have a measured wet-slip resistance value (a BPN value) of 20 or less, when measured according to ASTM E-303-93.

The clean recovery of the wet-slip resistance sheet can be evaluated by the following rub-off stain test.

Firstly, the wet-slip resistant sheet is arranged on the floor surface of a passageway where passersby wearing shoes walk (that is, the sheet is fixed to the floor surface with the back face of the substrate facing the floor surface), and a practical test is carried out. Such a passageway may be a passageway in a factory where only employees wearing safety shoes walk (not open to public). After a specific period (usually one week to one month) from the placement of the sheet, the ease of washing of the sheet with water is evaluated by comparing the ease with a new wet-slip resistant sheet, which has not been subjected to the above test. That is, the sheet is washed with water by a simple method, for example, with a brush, and whether the stains on the sheet can be removed is evaluated by eye. When PI exceeds 100 and the BPN value exceeds 100 in the above test, the clean recovery of the sheet is ranked NG (no good) (see Examples).

When the shape of the protrusion (11) is a frustum or a frustum with a rounded apex, the clean recovery is advantageously improved. The degree of the clean recovery may be evaluated using a clean recovery rate, which is measured according to JIS A 5712, as an index, although it can be measured by the above evaluation method.

Now, the clean recovery test will be explained.

As a sample, a wet-slip resistant sheet, which is cut to a square of 3 cm×3 cm is supplied. The surface of the sample is cleaned with a cloth impregnated with a 5% aqueous solution of a soap, and then the initial diffuse reflectance Y₀ is measured. Then, on the surface of the sample, the following stain component (1g) is smeared and kept standing for 30 minutes. Thereafter, the surface of the sample is scrubbed with a dry new cloth ten times to wipe the stain component off. Then, the diffuse reflectance Y₁ after wiping (after clean recovery) is measured.

The stain component is a mixture of white Vaseline (Japan Pharmacopoeia) and carbon black in a weight ratio of 10:1.

The percentage of the former diffuse reflectance based on the latter (Y=(Y₁/Y₀)×100) is calculated, and the Y value is used as a clean recovery (CR).

When the protrusion is in the form of a frustum or a frustum with a rounded apex, the clean recovery can be effectively increased, for example, to 60% or more.

The protrusion (11) shown in FIGS. 1 and 2 is in the form of a frustum, which corresponds to a pyramid, a part of which near the top is cut away so that the apex part has a flat surface. The frustum with a rounded apex corresponds to a frustum, the apex of which is rounded in a dome form.

When the apex (11t) of the protrusion is substantially flattened, the height (H) of the protrusion is the distance from the bottom (one end) of the protrusion to the flat surface on the top. When the protrusion is in the form of a frustum with a rounded apex and the apex has a curved surface, the height (H) is the distance from the bottom of the protrusion to the point on the rounded surface that is most distant from the bottom.

A ratio of the H₀ (the height of an untruncated pyramid corresponding to a frustum) to the actual height (H) of the frustum (H₀/H) is usually from 0.60 to 0.98, and preferably from 0.70 to 0.95 in the case of the frustum with a flattened apex, or usually from 0.70 to 1.00, and preferably from 0.75 to 0.98 in the case of the frustum with the rounded apex.

The shape of the bottom of the frustum or the frustum with the rounded apex may be a polygon. A polygon with a smaller number of sides is better, since the wet-slip resistance can be advantageously improved without deteriorating the clean recovery. The shape of the bottom of the frustum is preferably a square or a triangle, and is more preferably a triangle.

The protrusion may be in the form of a pyramid or a cone. The pointed apex of the pyramid or the cone may be advantageous, when the required level of the clean recovery is not so high (for example, when no graphics are present under the substrate), or when the resin composition effective to increase the clean recovery is used and the wet BPN value is increased as much as possible.

The apex angle of the protrusion is not limited, insofar as the measured BPN value of the anti-skid parts can be controlled in the specified range, and is preferably from 60 to 110 degrees. In this range, the BPN value can be easily increased. The apex angle of the pyramidal protrusion is a vertex angle of a side triangle of the pyramid having the vertex at the other end of the protrusion which is not bonded to the substrate. The largest vertex angle is used as the apex angle of the protrusion. In the case of a cone, the apex angle is a vertex angle of a triangle appearing on the vertical cross section of the cone having the vertex at the other end of the protrusion which is not bonded to the substrate.

The protrusions may include several types of protrusions having different shapes or sizes. In such a case, the size, the apex angle, PI, etc. of the protrusions are the average values of all the protrusions included in one cycle of the repeated pattern. The several types of the protrusions preferably have substantially the same height.

It is preferable to compound a hard resin and a surface-modifier in a resin composition for the formation of the protrusions so that the clean recovery properties are improved without relying on the function of the above shape factors, or with promoting the functions of the shape factors. Thereby, the firm adhesion of the stain materials is effectively prevented, and thus the clean recovery can be improved. More preferably the resin composition contains the surface-modifier, the hard resin and a plurality of hard beads dispersed in the hard resin.

The surface modifier may be a silicone base or fluorine-containing surface modifier. As a surface modifier, a coating type surface modifier disclosed in JP-A-6-240201 may be used.

The hard resin means a cured resin. The hard resin is usually formed of a mixture of a curable resin and a curing agent. The curing agent may be omitted, when the curable resin can be crosslinked in the absence of the curing agent.

The hard beads may be ceramic beads, inorganic oxide beads, etc. The Vickers hardness of the hard beads is preferably at least 1,000 kg/mm². The “Vickers hardness” is measured by mixing about 10 to 20 hard beads having a particle size of about 1 mm and 10 g of an epoxy resin and hardening them to form a cylindrical sample having a diameter of about 3 cm and a height of about 1 cm, abrading the sample to expose the beads on the surface and measuring the hardness with a micro hardness meter (HMV-1 manufactured by Shimadzu Corporation). A load of 300 g is applied, and a loading time is about 15 seconds.

The wet-slip resistant sheet (10) is used by bonding the back face of the substrate to the floor. Thus, in general, an adhesive layer (not shown) is fixedly provided on the back face of the substrate.

According to the present invention, it is possible to produce a wet-slip resistant structure with good wet-slip resistance comprising a floor surface of a building and the wet-slip resistant sheet of the present invention, which is fixed to the floor surface. For example, when the floor is a floor surface facing outdoors, or an indoor floor surface which is present near an entrance which faces outdoors. In such a case, a quantity of water which is carried onto the floor surface tends to form a slippery aqueous film. The wet-slip resistant structure of the present invention can effectively prevent the slippage of the passersby caused by the formation of the aqueous film.

Production of Wet-Slip Resistant Sheet

In the production of the wet-slip resistant sheet of the present invention, the protrusions may be formed by any conventional methods. In general, a sheet-form substrate of a resin composition having no protrusion on its surface is provided, and the substrate surface is embossed to form protrusions integral with the substrate. The resin composition from which the protrusions are formed is a relatively hard resin composition comprising a polymer.

For example, the polymer may be at least one polymer selected from the group consisting of polyurethane, vinyl chloride polymers, acrylic polymers, polyester, polycarbonate, polyamide, polyolefin, polystyrene, silicone, fluoropolymer and epoxy polymers (cured epoxy polymers). As described above, the polymer may be cured (crosslinked) with the crosslinking agent.

The hardness of the protrusions (i.e. the hardness of the resin composition) is usually from 2 to 10,000 MPa, preferably from 5 to 5,000 MPa in terms of a Young's modulus measured at 25° C.

The resin composition for forming the protrusions may contain various additives such as a surface-modifier, a curing agent, a surfactant, hard beads, a flame-retardant, a UV-ray absorber, an antioxidant, a tackifying resin, a colorant, an antibacterial, etc.

Usually, the embossing for the formation of the protrusions may be carried out by placing the precursor of the protective sheet between a processing roll and a back-up roll and transferring the surface roughness of the processing roll to the sheet. That is, a pressing roll, the surface of which has an uneven shape or roughness corresponding to those to be transferred to the surface of the protective layer, is pressed against the surface of the protective layer. Preferably, the embossing is carried out while heating. The heating temperature is usually from 120 to 270° C., and preferably from 130 to 260° C. The pressure is usually from 4 to 10 kg/cm² (about 0.4 to 1.0 MPa).

The processing roll is usually a steel roll having the plating of a metal (e.g. chromium, etc.), so that the surface roughness is precisely controlled. The back-up roll is usually a soft roll comprising a metal roll and a surface-covering material made of a soft material such as a rubber or cotton which is wrapped around the metal roll, although the back-up roll may be made of the same material as the processing roll. Other embossing conditions may be the same as those employed in the embossing of the surface of the protective layer of the conventional decorative sheet.

When the resin composition comprises the hard resin, preferably, a sheet-form laminate, which has a cushioning layer consisting of a thermoplastic resin layer adhered to the back face of the substrate, is used, and embossed. The thickness of the cushioning layer is usually from 25 to 500 μm.

The thickness of the wet-slip resistant sheet is not limited insofar as the effects of the present invention can be achieved, and the wet-slip resistant sheet having a small thickness to a large thickness may be used. The thickness of the wet-slip resistant sheet is usually from 0.06 to 2.5 mm, and preferably from 0.08 to 1.6 mm.

The height (H) of the protrusions is usually from 0.05 to 2 mm, preferably from 0.06 to 1.5 mm, and more preferably from 0.07 to 1 mm.

(Graphics-Protective Sheet)

An embodiment is explained, in which the wet-slip resistant sheet of the present invention is used as a graphics-protective sheet by making reference to FIG. 3. FIG. 3 is a schematic figure and thus the sizes of the elements, for example, the thicknesses of the layers, are different from the actual sizes.

The wet-slip resistant sheet (10) is used as the protective layer of the decorative layer (2) adhered to the surface (3s) of the floor (3). That is, the wet-slip resistant sheet (10) constitutes the decorative sheet (101) in combination with the decorative layer (2).

The wet-slip resistant sheet (10) is fixed to the surface (2s) of the decorative layer (2) through the adhesive layer (17). The adhesive layer (17) may be previously fixedly provided on the back face (1b) of the substrate (1) of the wet-slip resistant sheet.

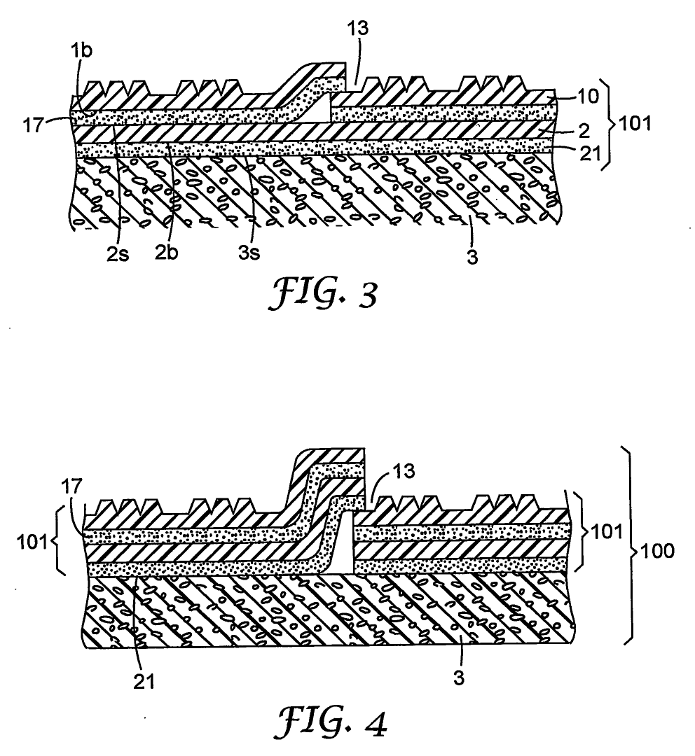

When the two wet-slip resistant sheets are connected and used on the decorative layer (2), the adhesive layer (17) of one wet-slip resistant sheet is laminated on the flat part (13) of the other wet-slip resistant sheet as shown in FIG. 4. FIG. 4 is a schematic figure and thus the sizes of the elements, for example, the thicknesses of the layers, are different from the actual sizes.

When the decorative sheets (101) are connected and used, the adhesive layer (21) of one decorative sheet (101) is laminated on the flat part (13) of the other decorative sheet (101).

The decorative layer (2) may be the same as that of the conventional decorative sheet, and is usually a film or a medium having a graphics drawn. The decorative sheet (101) is combined with the floor (3) to form the decorative wet-slip resistant structure (100). The whole thickness of the decorative sheet (101) (including the two adhesive layers 17 and 21) is not limited, but is usually from 0.1 to 1 mm. The thickness of the wet-slip resistant sheet assembled in the decorative sheet is usually from 0.06 to 0.5 mm, and preferably from 0.08 to 0.4 mm.

The wet-slip resistant sheet (10), when used as the graphics-protective sheet, preferably has a high light transmittance. In this case, the light transmittance is usually at least 65%, preferably at least 70%, particularly preferably at least 80%, when it is measured by illuminating the light on the back face (1b). When the light transmittance is too low, the visibility of the graphics drawn on the adherent surface such as the medium may deteriorate. Herein, the “light transmittance” is a light transmittance measured according to JIS K 7105 (Measuring method of light transmittance).

The adhesive layer (17) usually consists of a coating layer or a film of an adhesive such as a heat-sensitive adhesive, a pressure-sensitive adhesive, a hot-melt adhesive, a curing type adhesive, etc. The adhesive layer (17) preferably has a high light transmittance, which is usually at least 70%, and preferably at least 80%.

The adhesive layer (21) can be formed from the same adhesive as exemplified above, and preferably from a material comprising a pressure-sensitive adhesive, since the sheet can be fixed to the floor surface by pressing the sheet to the floor and thus the processing becomes easy. As an adhesive, one disclosed in JP-A-2002-505453 may be used. Advantageously, the adhesive layer (21) comprises a double-coated adhesive film having an elastically deformable layer such as a foam layer since the wet-slip properties are improved.

In the case of the wet-slip resistant structure described above, preferably, the graphics is placed below the substrate so that it can be seen through the substrate. Optionally, graphics includes some guiding information. The guiding information means a destination guidance such as a name of a place or a building to which the passageway is connected, a distance (including a time or the number of steps) to the place or building, the direction to the place or building (including an azimuth, etc.). The guiding information may contain the name of a building having the entrance, the owner of the building, the business performed in the building, a welcome message for visitors, etc.

### EXAMPLES

In Examples, wet-slip resistant sheets were produced by two different methods, which will be explained below:

Cutting Method (Protrusion Shape Type 2)

In Examples 1-3, a sheet was produced by a cutting method as follows:

The surface of a substrate made of an acrylic resin having a thickness of 2 mm (a plane size=300 mm×300 mm) was processed by cutting so that the substrate had desired anti-skid parts and flat parts. The shape of the protrusion was a triangular pyramid. The widths of the flat parts (a and c), the widths of the anti-skid parts (b and d), and the calculated BPN values are summarized in Table 1.

Embossing Method (Protrusion Shape Type 1)

In Examples 4-6, a sheet was produced by an embossing method as follows:

The surface of a substrate made of a vinyl chloride resin film having a thickness of 150 μm (a vinyl chloride resin film of BANDO Chemical Co., Ltd. having a light transmittance of 97%) was thermally embossed so that the substrate had desired anti-skid parts and flat parts. The thermal embossing was carried out by an embossing method using a processing roll and a back-up roll. The embossing conditions included a temperature of 180° C. and a pressure of 0.6 MPa.

The shape of the protrusion was a frustum of a triangular pyramid. The ratio of the height (H₀) of the frustum to the height (H) of the original triangular pyramid was about 0.8 to 0.9.

The widths of the flat parts, the widths of the anti-skid parts, and the calculated BPN values are summarized in Table 1.

### Comparative Examples 1 and 2

These Comparative Examples relate wet-slip resistant sheets having no flat parts. Thus, the sheet was lifted at the connected parts.

The sheets of these Comparative Examples were produced in the same manner as in Example 4 or Example 1 except that no flat part was provided. The measured BPN of the sheets are shown in Table 1.

### Comparative Example 3

In this Comparative Example, the positioning of the sheets was difficult and the sheet was lifted at the connected part, since the width of the flat part was small.

The sheet of this Comparative Example was produced in the same manner as in Example 4 except that the widths of the flat parts and the widths of the anti-skid parts were changed. The widths of the flat parts (a and c), the widths of the anti-skid parts (b and d), and the calculated BPN values are summarized in Table 1.

### Comparative Examples 4-10 and 13

These Comparative Examples relate to sheets having a calculated BPN value smaller than 35 and thus having insufficient wet-slip resistance property.

The sheets of these Comparative Examples were produced in the same manner as in Example 1, Example 4 or Example 5 except that the widths of the flat parts and the widths of the anti-skid parts were changed. The widths of the flat parts, the widths of the anti-skid parts, and the calculated BPN values are summarized in Table 1.

### Comparative Examples 11, 12 and 14

The slip-resistant sheets of these Comparative Examples were produced in the same manner as in Example 1 except that the widths of the flat parts and the widths of the anti-skid parts were changed. The sheets partly caused slipping since the width of the flat parts was large. The widths of the flat parts, the widths of the anti-skid parts, and the calculated BPN values are summarized in Table 1.

The wet-slip resistance property and the positioning property are evaluated according to the following criteria:

Wet-slip resistance property:

A: No slipping.

B: Partly slipping.

C: Slipping.

Positioning property:

A: One sheet is laminated only on the surface of the flat sheet at the edge of the other sheet along the entire width of the other sheet (1200 mm).

B: One sheet is laminated also on the surface of the anti-skid part of the other sheet.

TABLE 1

| | | Flat part | | Anti-skid | | Calcu- | | | Change of | |
|---|---|---|---|---|---|---|---|---|---|---|
| | | width | | part width | | lated | | | connected | |
| | Shape of | (mm) | | (mm) | | BPN | Wet-slip | | part | Protrusion |
| | Flat parts | a | c | b | d | X | resistance | Positioning | over time | shape |
| 1 | Lattice | 10 | 10 | 20 | 20 | 38 | A | — | None | Type 2 (B) |
| 2 | Lattice | 10 | 10 | 30 | 30 | 42 | A | — | None | Type 2 |
| 3 | Lattice | 20 | 20 | 60 | 60 | 43 | A | — | None | Type 2 |
| 4 | Lattice | 10 | 10 | 50 | 50 | 35 | A | A | None | Type 1 (A) |
| 5 | Stripe | 10 | — | 30 | — | 37 | A | A | None | Type 1 |
| 6 | Strip | 30 | — | 90 | — | 37 | A | A | None | Type 1 |
| C.1 | None | — | — | — | — | 43* | A | — | Peeled | Type 1 |
| C.2 | None | — | — | — | — | 63* | A | — | Peeled | Type 2 |
| C.3 | Lattice | 5 | 5 | 5 | 5 | 24 | C | B | Partly | Type 1 |
| | | | | | | | | | peeled | |
| C.4 | Lattice | 10 | 10 | 10 | 10 | 24 | C | A | None | Type 1 |
| C.5 | Lattice | 10 | 10 | 30 | 30 | 32 | C | A | None | Type 1 |
| C.6 | Lattice | 10 | 10 | 10 | 10 | 29 | C | — | None | Type 2 |
| C.7 | Lattice | 20 | 20 | 20 | 20 | 24 | C | A | None | Type 1 |
| C.8 | Lattice | 20 | 20 | 60 | 60 | 32 | C | A | None | Type 1 |
| C.9 | Lattice | 20 | 20 | 20 | 20 | 29 | C | — | None | Type 2 |
| C.10 | Stripe | 10 | — | 10 | — | 30 | C | A | None | Type 1 |
| C.11 | Lattice | 30 | 30 | 30 | 30 | 22 | B | A | None | Type 1 |
| C.12 | Lattice | 30 | 30 | 90 | 90 | 32 | B | A | None | Type 1 |
| C.13 | Stripe | 30 | — | 30 | — | 30 | C | A | None | Type 1 |
| C.14 | Stripe | 50 | — | 150 | — | 37 | B | A | None | Type 1 |

Note:
*Measured BPN.

Decorative Sheet

Using the slip resistant sheets of the Examples, a graphics-protective sheet of each sample was produced and then a decorative sheet of each sample was produced using the graphics-protective sheet as follows:

Firstly, a coating liquid containing an acrylic self-adherent polymer was applied on a release paper so that a dry thickness was 30 μm and dried to form an adhesive layer (with a release paper). Then, the adhesive layer was laminated on the back face of the substrate of the slip resistant sheet to obtain a graphics-protective sheet. Finally, the release paper was removed, and the protective sheet was laminated on the surface having the graphics drawn on a film (having a thickness of 80 μm) through the adhesive layer to finish the decorative sheet of each Example.
Relationship of arrangement density (>) and profile index (PI) with measured BPN:

To confirm the relationship of an arrangement density (D) and a profile index (PI) with a measured BPN value, a sheet having only anti-skid parts, was produced (Samples 1-27).

Production of Type 1 Wet-Slip Resistant Sheets

(Samples 8, 13, 14 and 22-27)

The type 1 wet-slip resistant sheet was produced by thermally embossing the surface of a substrate made of a vinyl chloride resin film having a thickness of 150 μm (a vinyl chloride resin film from BANDO Chemical Co., Ltd. having a light transmittance of 97%) to form protrusions having a specific PI and a height. The thermal embossing was carried out by an embossing method using a processing roll and a back-up roll. The embossing conditions included a temperature of 180° C. and a pressure of 0.6 MPa.

The shape of the protrusion of the type 1 sheet was a frustum of a triangular pyramid. The ratio of the height (H₀) of the frustum to the height (H) of the original triangular pyramid was about 0.8 to 0.9.

The height (H), the arrangement density (D), PI, the shape and the apex angle of the protrusions of the sheet produced in each Example are shown in Table 2.

A slip resistant sheet was produced with changing the emboss pattern to a pattern comprising protrusions with non-uniform shapes and non-uniform arrangements and thus having non-uniform roughness. That is, the sheets were produced in the same manner as in the above production method but the emboss pattern was changed to the random pattern.

A typical area of the surface of this slip resistant sheet was selected and observed by an optical microscope (with a magnification of 100 times). The groups of the irregularly shaped protrusions having different heights from group to group were observed, and in the typical area, the groups of the protrusions having a height of 0.05 mm or larger and the groups of the protrusions having a height of less than 0.05 mm ranged irregularly. The average height of the protrusions was about 0.1 to 0.2 mm, which was relatively large.

The height (C), the arrangement density (D), PI, the shape and the apex angle of the protrusions of the sheet produced in each Example are shown in Table 2.

Production of Type 2 Wet-Slip Resistant Sheets

(Samples 1-7, 9-12 and 15-21)

The type 2 wet-slip resistant sheet was produced by thermally embossing the surface of a substrate made of a vinyl chloride resin film having a thickness of 150 μm (a vinyl chloride resin film from BANDO Chemical Co., Ltd. having a light transmittance of 97%) to form protrusions having a specific PI and a height. The shape of the protrusion of the type 2 sheet was a frustum of a triangular pyramid.

The height (H), the arrangement density (D), PI, the shape and the apex angle of the protrusions of the sheet produced in each Example are shown in Table 2. These values were measured using an optical microscope.

With the samples produced in the above, the following properties were evaluated:

1) Measured BPN value: The BPN value was measured according to ASTM E-303-93.

2) Clean recovery (CR): The clean recovery was measured according to JIS A 5712.

3) Rub-off Stain: A sample of the slip-resistant sheet of each Example having a surface area of 5 cm×5 cm was adhered to the surface of a passageway where only employees wearing safety shoes walk, and left as it was for one month. Thereafter, the surface of the sheet was washed with water using a brush, and it was visually observed whether the stains could be removed from the surface of the sheet, and the condition of the sheet surface was compared with that of the new sheet prior to the test. Based on the results, when the rub-off stain caused by the abrasion marks due to the shoe soles could be completely removed, the rub-off stain was evaluated as “GOOD”. When the stain was not entirely removed, but the percentage of the area from which the stain could not be removed was less than about 40%, and the appearance did not deteriorate, the rub-off stain was evaluated as “ACCEPTABLE”. When the percentage of the area from which the stain could not be removed was about 40% or more, and the sheet was stained such that the appearance did deteriorate, the rub-off stain was evaluated as “NO GOOD”.

The results of the evaluations are shown in Table 2.

The wet-slip resistant sheets of Samples 1-20 had good wet-slip resistant properties and clean recovery.

In Sample 21 in which PI was 112, the rub-off stain of the surface was judged NO GOOD. In Samples 22-26 in which PI was 4 or less, the BPN values were all 30 or less, and the wet-slip resistant properties were judged NO GOOD.

The above results of the evaluations will be examined more in detail.

The sheets of Samples 6-20 having PI of 40 or less had the rub-off stain better than those of Samples 1-5 having the relatively large PI. To achieve a clean recovery of 60% or more, the sheets having PI of 40 or less and the flat apex of the protrusion were advantageous, and the triangular pyramid was more advantageous than the pyramid.

TABLE 2

| | | | Clean | | | | Apex | | |
|---|---|---|---|---|---|---|---|---|---|
| Sample | | Measred | recovery | Rub-off | | H | angle | D | |
| No. | PI | BPN | [%] | stain | Shape | [mm] | [deg.] | [/cm²] | Type |
| 1 | 75 | 86 | 4 | Acceptable | pyramid | 0.6 | 60 | 208 | 2 |
| 2 | 58 | 91 | 5 | Acceptable | triang. | 0.3 | 79 | 642 | 2 |
| | | | | | pyramid | | | | |
| 3 | 58 | 92 | 16 | Acceptable | triang. | 0.4 | 79 | 361 | 2 |
| | | | | | pyramid | | | | |
| 4 | 58 | 90 | 4 | Acceptable | triang. | 0.8 | 79 | 90 | 2 |
| | | | | | pyramid | | | | |
| 5 | 58 | 87 | 4 | Acceptable | triang. | 0.6 | 79 | 160 | 2 |
| | | | | | pyramid | | | | |
| 6 | 25 | 40 | 24 | Good | pyramid | 0.2 | 90 | 625 | 2 |
| 7 | 25 | 60 | 30 | Good | pyramid | 0.4 | 90 | 156 | 2 |
| 8 | 20 | 43 | 73 | Good | triang. | 0.09 | flat | 2470 | 1 |
| | | | | | pyramid | | top | | |
| | | | | | frustum | | | | |
| 9 | 20 | 95 | 14 | Good | triang. | 0.15 | 108 | 867 | 2 |
| | | | | | pyramid | | | | |
| 10 | 19 | 85 | 18 | Good | triang. | 0.3 | 108 | 214 | 2 |
| | | | | | pyramid | | | | |
| 11 | 19 | 80 | 15 | Good | triang. | 0.2 | 108 | 481 | 2 |
| | | | | | pyramid | | | | |
| 12 | 19 | 66 | 18 | Good | triang. | 0.4 | 108 | 120 | 2 |
| | | | | | pyramid | | | | |
| 13 | 14 | 43 | 70 | Good | triang. | 0.2 | flat | 360 | 1 |
| | | | | | pyramid | | top | | |
| | | | | | frustum | | | | |
| 14 | 11 | 35 | 78 | Good | triang. | 0.09 | flat | 1350 | 1 |
| | | | | | pyramid | | top | | |
| | | | | | frustum | | | | |
| 15 | 8.4 | 40 | 41 | Good | pyramid | 0.3 | 120 | 93 | 2 |
| 16 | 8.4 | 64 | 18 | Good | pyramid | 0.1 | 120 | 833 | 2 |
| 17 | 8.3 | 67 | 50 | Good | pyramid | 0.2 | 120 | 208 | 2 |
| 18 | 8.3 | 40 | 33 | Good | pyramid | 0.4 | 120 | 52 | 2 |
| 19 | 6.4 | 49 | 58 | Good | triang. | 0.1 | 134 | 642 | 2 |
| | | | | | pyramid | | | | |
| 20 | 6.4 | 46 | 50 | Good | triang. | 0.2 | 134 | 160 | 2 |
| | | | | | pyramid | | | | |
| 21 | 112 | 102 | 4 | N.G. | triang. | 0.6 | 62 | 312 | 2 |
| | | | | | pyramid | | | | |
| 22 | 4.0 | 30 | 75 | Good | triang. | 0.04 | flat | 2470 | 1 |
| | | | | | pyramid | | top | | |
| | | | | | frustum | | | | |
| 23 | 3.6 | 29 | 72 | Good | triang. | 0.1 | flat | 360 | 1 |
| | | | | | pyramid | | top | | |
| | | | | | frustum | | | | |
| 24 | 1.2 | 28 | 80 | Good | triang. | 0.03 | flat | 1350 | 1 |
| | | | | | pyramid | | top | | |
| | | | | | frustum | | | | |
| 25 | 0.9 | 30 | 73 | Good | triang. | 0.15 | flat | 40 | 1 |
| | | | | | pyramid | | top | | |
| | | | | | frustum | | | | |
| 26 | 0.1 | 26 | 85 | Good | triang. | 0.06 | flat | 40 | 1 |
| | | | | | pyramid | | top | | |
| | | | | | frustum | | | | |
| 27 | 14.1 | 45 | 44 | Good | random | 0.15 | — | 625 | 1 |
| | | | | | emboss | | | | |

1. A wet-slip resistant sheet comprising:
a substrate having a surface and a back face opposing to said surface, and
anti-skid parts and flat parts provided on said surface of the substrate, wherein each of said anti-skid parts is separated by said flat parts.

2. The wet-slip resistant sheet according to claim 1, wherein said flat parts are in the form of lattices or stripes.

3. The wet-slip resistant sheet according to claim 2, wherein said lattice-form flat parts have a width of 7 mm to 25 mm, and a calculated wet-slip resistance value (calculated BPN value) of at least 35, said calculated wet-slip resistance value being defined by the formula (1):
X=Xf+(Xr−Xf)bd/(a+b)(c+d) (1)
in which
Xr is a measured wet-slip resistance value (a measured BPN value) of anti-skid parts according to ASTM E-303-93,
Xf is a measured wet-slip resistance value (a measured BPN value) of flat parts according to ASTM E-303-93,
a is an average width of flat parts in one direction (unit: mm),
b is an average width of anti-skid parts in one direction (unit: mm),
c is an average width of flat parts in the other direction (unit: mm), and
d is an average width of anti-skid parts in the other direction (unit: mm).

4. The wet-slip resistant sheet according to claim 2, wherein said stripe-form flat parts have a width of 7 mm to 40 mm, and a calculated wet-slip resistance value (calculated BPN value) of at least 35, said calculated wet-slip resistance value being defined by the formula (1′):
X=Xf+(Xr−Xf)b/(a+b) (1′)
in which
Xr is a measured wet-slip resistance value (a measured BPN value) of anti-skid parts according to ASTM E-303-93,
Xf is a measured wet-slip resistance value (a measured BPN value) of flat parts according to ASTM E-303-93,
a is an average width of flat parts (unit: mm), and
b is an average width of anti-skid parts (unit: mm).

5. The wet-slip resistant sheet according to any one of claims 1 to 4, wherein said anti-skid parts comprise a plurality of protrusions of a resin composition, one end of each of which is bonded to said surface of the substrate, wherein said protrusions are regularly arranged on said surface of the substrate with a specific repeating pattern,
characterized in that an arrangement density (D) of said protrusions in said anti-skid parts is in the range between 50 protrusions/cm² to 3,000 protrusions/cm²,
a profile index (PI) of said protrusions is in the range between 5 and 100, wherein the profile index (PI) is defined by the formula (2):
PI=D×H² (2)
in which D is an arrangement density of the protrusions (unit: protrusions/cm²), and H is a height of the protrusion (unit: mm),
and a measured wet-slip resistance value (a BPN value), which is measured according to ASTM E-303-93, is at least 35.

6. The wet-slip resistant sheet according to any one of claims 1 to 5, wherein said flat parts have a measured wet-slip resistance value (a BPN value) of 20 or less, when measured according to ASTM E-303-93.

7. A decorative sheet comprising a wet-slip resistant sheet according to any one of claims 1 to 6, and a decorative sheet having graphics fixed to the back surface of the substrate of the wet-slip resistant sheet.

8. A wet-slip resistant structure comprising a floor of a construct and a wet-slip resistant sheet according to any one of claims 1 to 6 which is fixed to the surface of said floor, wherein said surface is a floor surface facing outdoors, or an indoor floor surface which is present near an entrance which faces outdoors.
